(19) United States
(12) Patent Application Publication
(10) Pub. No.: US 2018/0009603 A1
(43) Pub. Date: Jan. 11, 2018

(54) Vacuum Channel Trash Receptacle

(71) Applicant: Derek T. Asakura, Bellingham, WA (US)

(72) Inventor: Derek T. Asakura, Bellingham, WA (US)

(21) Appl. No.: 15/205,432

(22) Filed: Jul. 8, 2016

(51) Int. Cl. B65F 1/06

(52) U.S. Cl. CPC B65F 1/068

(57) ABSTRACT

A vacuum channel trash receptacle for easy removal of trash bags. The vacuum channel trash receptacle includes an inner surface; an outer surface and at least one vacuum channel. The vacuum channels are molded into the design of the internal and are on the external surface and top of the trash receptacle and made of material same as the trash receptacle. This allows air to flow down the length of the trash receptacle relieving the vacuum created by the liner bag and inner and bottom walls of the receptacle.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD

At least some embodiments disclosed herein relate, in general, to relate to the field trash bag removal mechanism from trash receptacles, and more specifically relates to trash receptacles that incorporate a means of releasing the vacuum typically created between the liner bag and the inner walls and bottom of the receptacle.

### BACKGROUND

When trash liners are full or over-filled, then those trash liners becomes nearly impossible to pull out of a trash can, due to the vacuum created from the trash liner suctioning itself to the inside of a trash can. Many times it takes two people to take out the trash (one to hold the trash can, and the other to pull out the full trash liner).

A simple trash receptacles with vacuum channel for easy removal of the trash bags would surely be accepted by the industry.

### SUMMARY

The intent of the embodiments of the present disclosure is providing a vacuum channel trash receptacle which facilitates the easy removal of the trash bags from the receptacle. The vacuum channel trash receptacle may include, but not limited to externally molded vacuum channel.

One aspect of the embodiments of the present disclosure relate to a vacuum channel trash receptacle comprising a vacuum channel molded into the design of the internal and is on the external surface of the trash receptacle and made of material same as the trash receptacle.

Various embodiments of the present disclosure provide the advantage of easy removal of trash bags from the trash receptacle by allowing the air to travel down the length of the channel to relieve the vacuum created by the liner and the receptacle walls.

Various embodiments of the present disclosure provide the advantage of reducing the force up to 50% required for removal of trash bags from the trash receptacle.

Various embodiments of the present disclosure provide the advantage of creating a vertical airway between the trash bag and the curved inner surface of the trash receptacle, such that the trash bag slides easily along the inner surface of the trash receptacle.

In another aspect of the embodiments of the present disclosure the vacuum channels are molded throughout the length and the top of the trash receptacle this will allow like designed trash receptacles to be nested into each other which will allow easy distribution and merchandising of the trash receptacle.

It is to be understood that the scope of this disclosure is not limited in its application to the details of construction and to the arrangements of the components set forth in the following description or illustrated in the drawings. Other embodiments are capable of being practiced and carried out in various ways. Also, it is to be understood that the phraseology and terminology employed herein are for the purpose of description and should not be regarded as limiting.

These together with other features of the embodiments of the present disclosure are provided in this disclosure.

### BRIEF DESCRIPTION OF THE DRAWINGS

The embodiments are illustrated by way of example and not limitation in the figures of the accompanying drawings in which like references indicate similar elements.

FIG.1 shows a top view of the vacuum channel trash receptacle;

FIG. 2 shows a front view of the vacuum channel trash receptacle; and

FIG. 3 shows two vacuum channel trash receptacles being nested or inserted into each other.

### DETAILED DESCRIPTION

In the following detailed description, reference is made to the accompanying drawings which form a part hereof, and in which is shown by way of illustration specific embodiments. It is to be understood that the embodiments may be combined, or that other embodiments may be utilized and that structural and logical changes may be made without departing from the spirit and scope of the embodiments of the present disclosure. The following detailed description is, therefore, not to be taken in a limiting sense, and the scope of the embodiments of the present disclosure is defined by the appended claims and their equivalents.

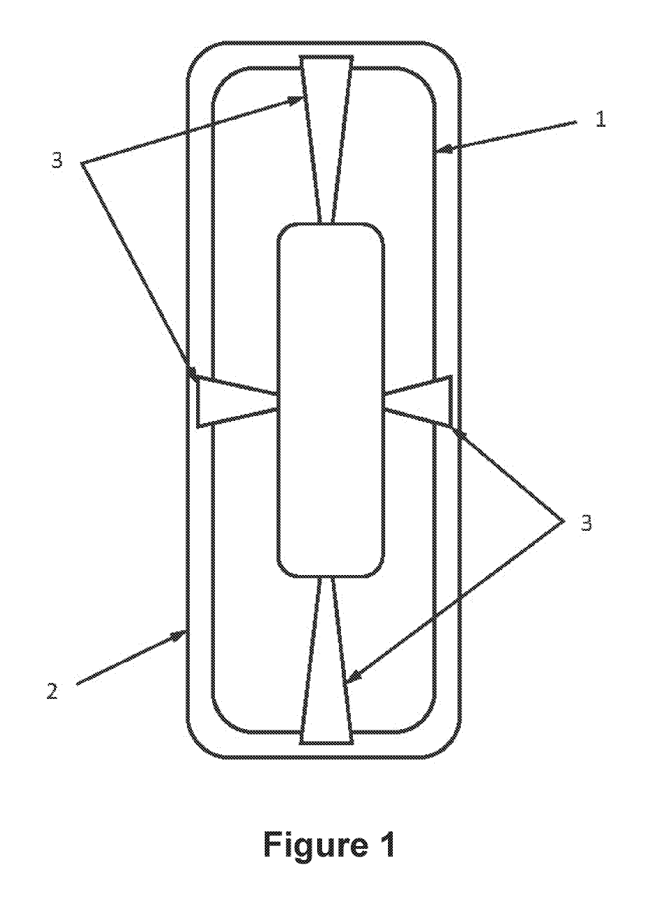

Referring now to the drawings, wherein like reference characters designate identical, or corresponding parts throughout the figures, and in particular FIGS. 1, 2, and 3 shows various embodiments of a vacuum channel trash receptacle.

FIG. 1 shows top view of the vacuum channel trash receptacle including, an inner surface 01, an outer surface 02, and a plurality of vacuum channels 03.

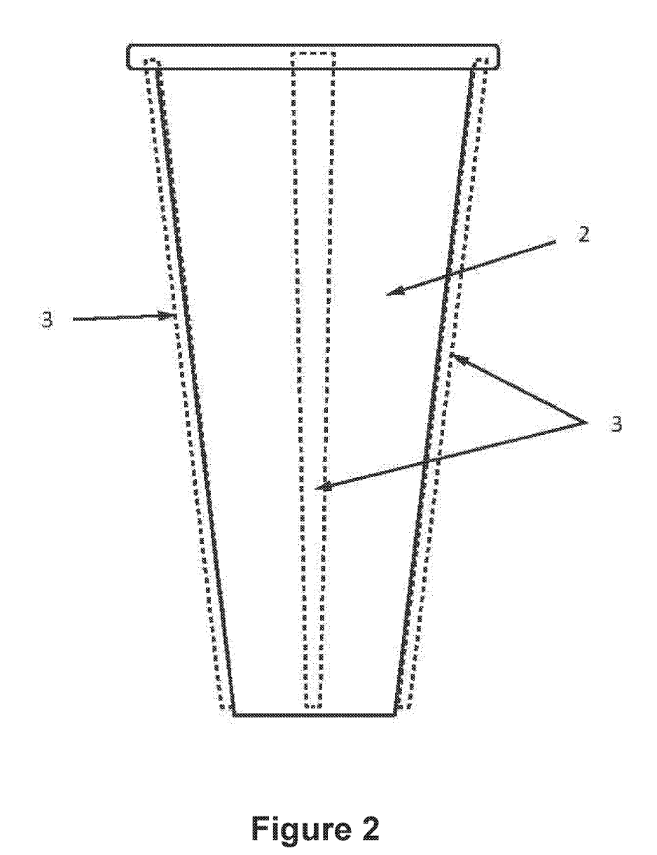

FIG. 2 shows front view of the vacuum channel trash receptacle including, an outer surface 02, and a plurality of vacuum channels 03.

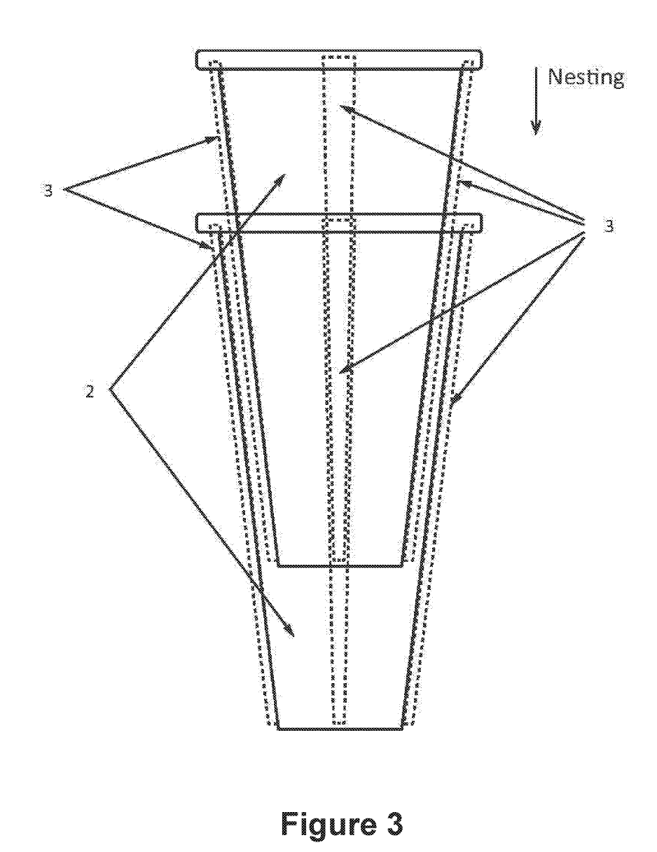

FIG. 3 shows front view of two vacuum channel trash receptacle including, an outer surface 02, and a plurality of vacuum channels 03 being nested or inserted into each other.

In general, the embodiments of the present disclosure provides a vacuum channel trash receptacle including the inner surface 01, the outer surface 02, and at least one vacuum channel 03.

The vacuum channels 03 run the vertical length of the trash receptacle molded into the inner 01 and outer surface 02 including the top opening. The vacuum channels 03 will allow air to flow down the length of the trash receptacle relieving the vacuum created by the liner bag and inner and bottom walls of the receptacle. Additionally by molding the vacuum channels 03 through the length and top of the trash receptacle will allow like designed trash receptacles to be nested into each other which will allow easy distribution and merchandising of the trash receptacle.

In various embodiments of the embodiments of the present disclosure the vacuum channel trash receptacle comprises vacuum channels 03 molded into the inner surface 01 and outer 02 of the trash receptacle and made of material same as the trash receptacle. In various embodiments, the at vacuum channels 03 are semi-cylindrical, hollow, and molded into the vacuum channel trash receptacle

In an embodiment, the vacuum channel trash receptacle can be cylindrical, rectangular, or square in cross-section. and is made of durable lightweight plastic, including the inner surface 01, the outer surface 02, and the vacuum channels 03. In the illustrated embodiment of the embodiments of the present disclosure there are four vacuum channels 03 located on diagonally opposite ends of the outer surface 02 of the cylindrical vacuum channel trash receptacle.

In a preferred embodiment the embodiments of the present disclosure provides the vacuum channel trash receptacle is cubical and made of durable lightweight plastic including the inner surface 01, the outer surface 02, and the vacuum channels 03. In this particular embodiment of the embodiments of the present disclosure there are four vacuum channels 03 located on opposite ends of the outer surface 02 of the cubical vacuum channel trash receptacle.

It is to be understood that the above description is intended to be illustrative, and not restrictive. For example, the above-discussed embodiments may be used in combination with each other. Many other embodiments will be apparent to those of skill in the art upon reviewing the above description.

While the embodiments of the present disclosure has been described with reference to particular embodiments, it should be understood that the embodiments are illustrative and that the scope of the disclosure is not limited to these embodiments. Many variations, modifications, additions, and improvements to the embodiments described above are possible. It is contemplated that these variations, modifications, additions, and improvements fall within the scope of this disclosure and the appended claims.

1. A vacuum channel trash receptacle comprising:
an inner surface;
an outer surface; and
at least one vacuum channel.

2. The vacuum channel trash receptacle of claim 1, wherein the vacuum channel trash receptacle is made from plastic.

3. The vacuum channel trash receptacle of claim 1, wherein the at least one vacuum channel comprises a plurality of vacuum channels molded into the vacuum channel trash receptacle on the inner surface and the outer surface of the vacuum channel trash receptacle.

4. The vacuum channel trash receptacle of claim 1, wherein the at least one vacuum channel is semi-cylindrical, hollow, and molded into the vacuum channel trash receptacle.

5. The vacuum channel trash receptacle of claim 1, wherein the at least one vacuum channel runs vertically from the bottom to the top of the vacuum channel trash receptacle.
